(19) United States
(12) Patent Application Publication
(10) Pub. No.: US 2013/0058190 A1
(43) Pub. Date: Mar. 7, 2013

(54) PLAY DOUGH MIXER

(71) Applicants: Melissa Jane McDonald, Warwick (AU); Edward Joseph Khoury, Bateman (AU)

(72) Inventors: Melissa Jane McDonald, Warwick (AU); Edward Joseph Khoury, Bateman (AU)

(21) Appl. No.: 13/635,015

(22) PCT Filed: Mar. 11, 2011
(86) PCT No.: PCT/AU2011/000269

§ 371 Date: Sep. 14, 2012

(30) Foreign Application Priority Data
Mar. 15, 2010 (AU) 2010901052

(51) Int. Cl. B01F 7/16

(52) U.S. Cl. 366/302; 366/314

(57) ABSTRACT

A play dough mixer comprising a mixing vessel having a lower wall and a side wall extending upwardly from the periphery of the circular lower wall. A blade his mounted adjacent the lower wall of the mixing vessel for rotation about a rotation axis. The blade comprises a planar member oriented radially with respect to the rotation axis. A drive motor is provided for rotating the blade and one or more longitudinal projections extend inwardly from an inner surface of the side wall. Each projection includes a lower face located above and parallel to the lower wall of the mixing vessel such that a gap his defined therebetween. The blade passes through the gaps during rotation.

### FIELD OF THE INVENTION

The present invention relates to a mixing device for making play dough.

### BACKGROUND TO THE INVENTION

Play dough has long been used by children for modelling and for games. Such play dough is commonly available for purchase in ready to use form. The play dough is generally sold in individual receptacles with each one containing a portion of play dough of a different colour.

As children use play dough, the different colours used tend to become mixed together over time. Also, the play dough is often left out of the containers, resulting in the dough mixture drying out. For these reasons, play dough purchased for children often has only a limited lifespan. This limited lifespan can deter parents from purchasing the play dough for their children.

There are play dough recipes available, with which parents can create their own dough mixture for much less expense than the versions available for sale. Some of these recipes require cooking and others do not. All however require a reasonable amount of time and effort to prepare, which again can deter parents from making such play dough.

The present invention relates to a mixing device specifically constructed for use in preparing play dough mixtures. While general purpose mixing devices are available, the construction of the present mixing device is particularly aimed at providing an easy to use device that produces a consistent mixture of play dough for children's use.

### SUMMARY OF THE INVENTION

According to one aspect of the present invention there is provided a play dough mixer comprising:

a mixing vessel having a lower wall and a side wall extending upwardly from the periphery of the circular lower wall;

a blade mounted adjacent the lower wall of the mixing vessel for rotation about a rotation axis, the blade comprising a planar member oriented radially with respect to the rotation axis;

a drive motor for rotating the blade; and

one or more longitudinal projections extending inwardly from an inner surface of the side wall;

wherein each projection includes a lower face located above and parallel to the lower wall of the mixing vessel such that a gap is defined therebetween and wherein the blade during rotation passes through said gaps.

Preferably each of the projections are tapered such that the projections increase in cross sectional size from an upper end to the lower end.

Preferably each projection has a generally triangular cross section such that first and second side faces of the projections are defined extending into the mixing vessel.

In one embodiment, the first and second side faces are orientated at an acute angle to each other.

In a preferred embodiment, the upper ends of the projections taper to have a zero cross sectional size.

In one embodiment, a pair of projections are provided located on the inner surface of the side wall on opposite sides of the blade.

The blade is preferably secured at a first end thereof to a rotating hub.

Preferably the blade includes a stepped upper edge such that the upper edge includes a first portion and a second portion joined by a shoulder portion, the first portion being generally parallel to the lower wall of the mixing vessel and adjacent the rotating hub and second portion being generally parallel to the lower wall of the mixing vessel and remote from the rotating hub.

In one embodiment, the first portion is located above the lower faces of the projections and the second portion is located below the lower faces of the projections such that the second portion extends into the gaps defined under the projections.

The drive motor is preferably provided inside a motor housing located alongside the mixing vessel and the mixing vessel is locatable on a vessel base extending outwardly from a lower end of the motor housing.

Preferably the drive motor is provided with a first drive shaft that is coupled to a second drive shaft in the vessel base such that rotation of the drive motor rotates the second drive shaft and the second drive shaft engages with the mixing vessel on the vessel base to rotate the blade.

According to a further aspect of the present invention, there is provided a play dough mixer comprising:

a motor housing having a drive motor mounted therein, the drive motor provided to rotate a first drive shaft;

a vessel base extending outwardly from a lower end of the motor housing;

a mixing vessel detachably mountable to an upper surface of the vessel base such that when mounted to the vessel base the mixing vessel is located alongside the motor housing;

a second drive shaft mounted within the vessel base;

wherein the first drive shaft is coupled to the second drive shaft such that rotation of the drive motor rotates the second drive shaft and the second drive shaft engages with the mixing vessel on the vessel base to rotate a blade provided within the mixing vessel.

Preferably the motor housing and the mixing vessel are both cylindrical in shape and the longitudinal axes of the motor housing and the mixing vessel are parallel and vertical when the mixing vessel is received on the vessel base.

In one embodiment, a first drive wheel is connected to the first shaft below the drive motor, a second drive wheel is provided on the second shaft within the vessel base and a drive belt connects the first drive wheel to the second drive wheel such that rotation of the first shaft by the drive motor rotates the blade.

A power button may be provided on an upper end of the motor housing such that depressing the power button activates the drive motor.

A timer may be provided such that the drive motor operates for a predetermined time period once activated before switching off.

### BRIEF DESCRIPTION OF THE DRAWINGS

The invention will now be described, by way of example, with reference to the following drawings in which:

FIG. 1 is an upper perspective view of a play dough mixer in accordance with the present invention;

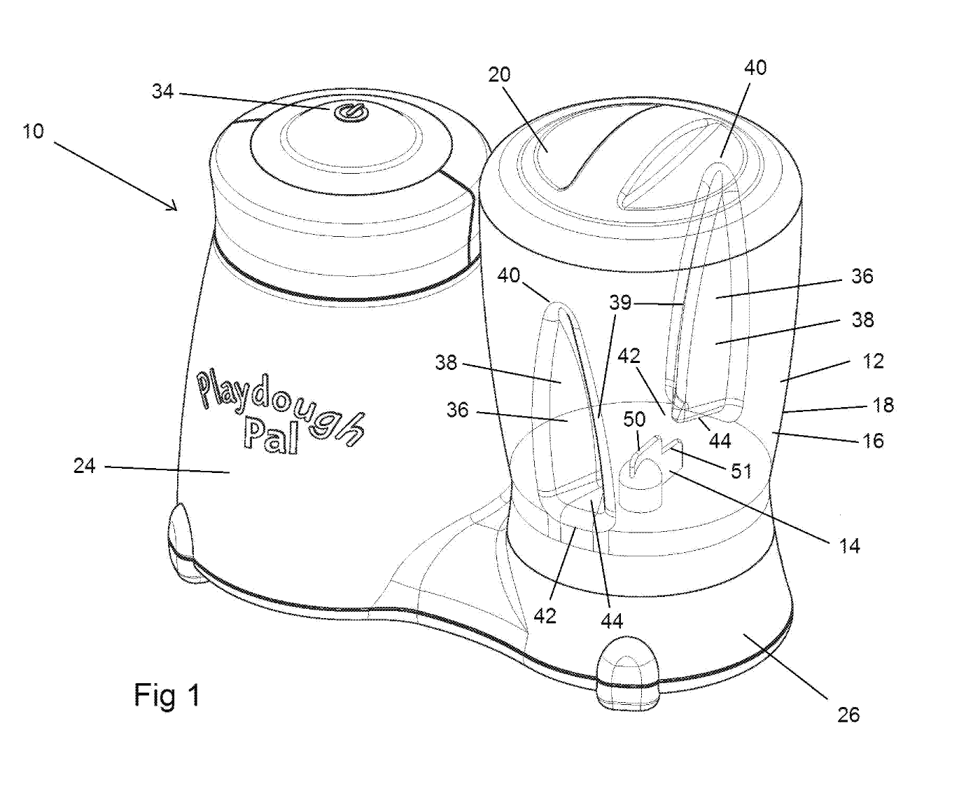

FIG. 2 is an end cross sectional view through the mixing vessel of the play dough mixer of FIG. 1;

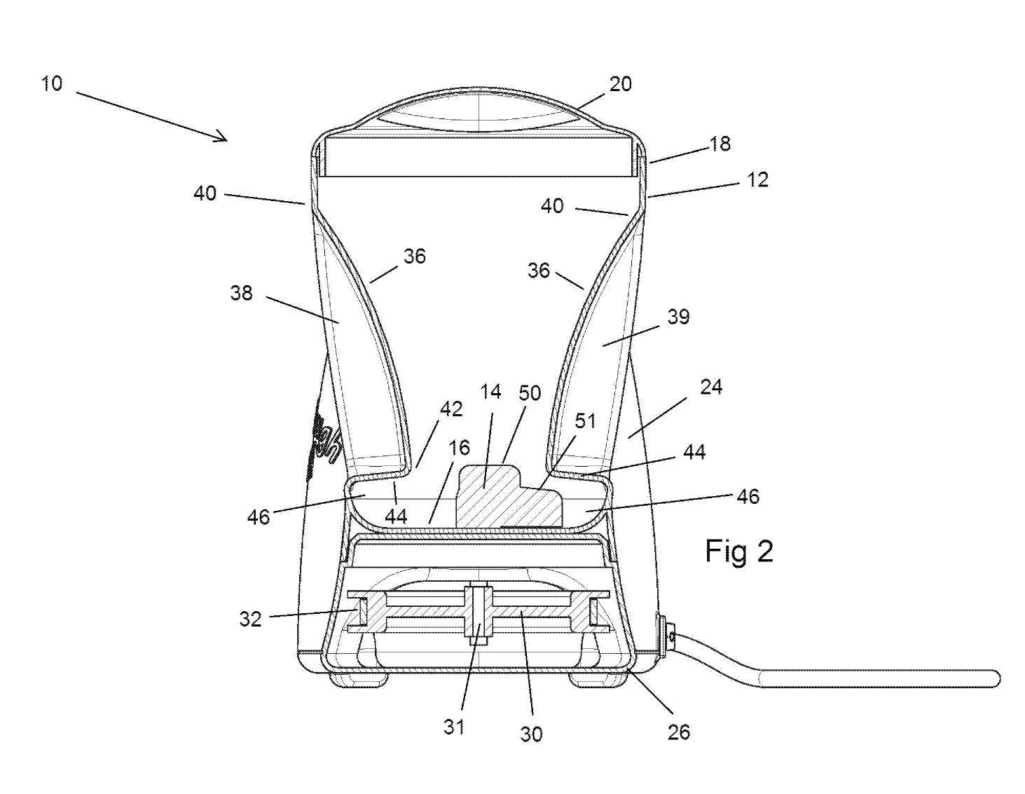

FIG. 3 is a side cross sectional view through the mixing vessel and motor housing of the play dough mixer of FIG. 1;

FIG. 4 is a wire frame representation of the play dough mixer of FIG. 1;

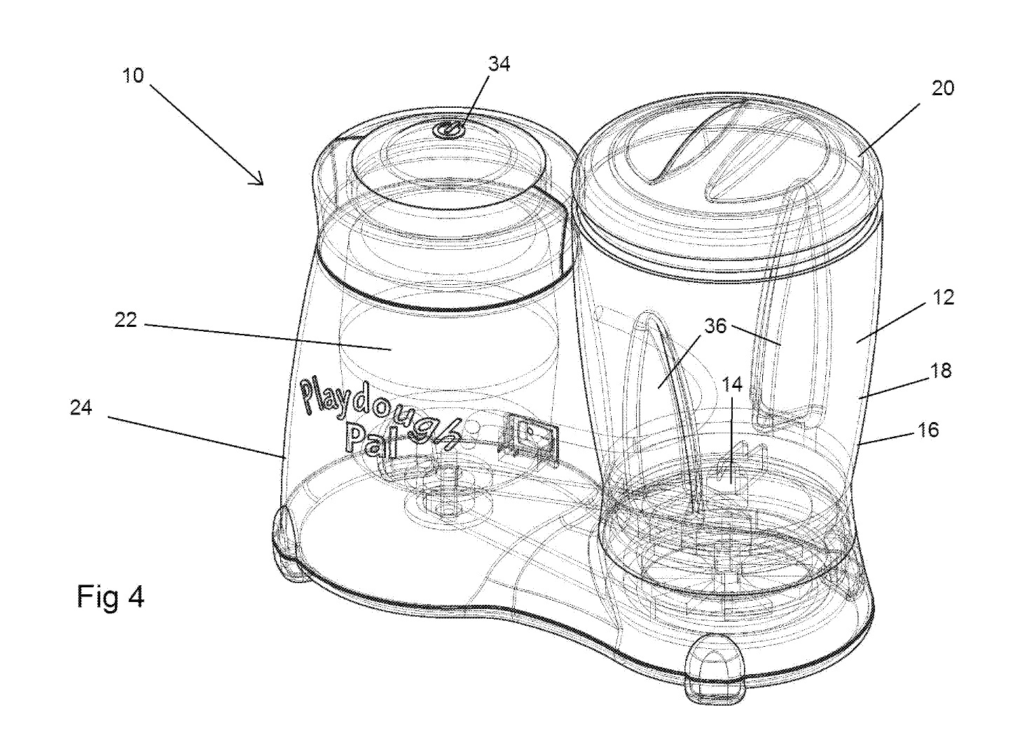

FIG. 5 is a perspective view of the play dough mixer of FIG. 1 cut through the mixing vessel; and

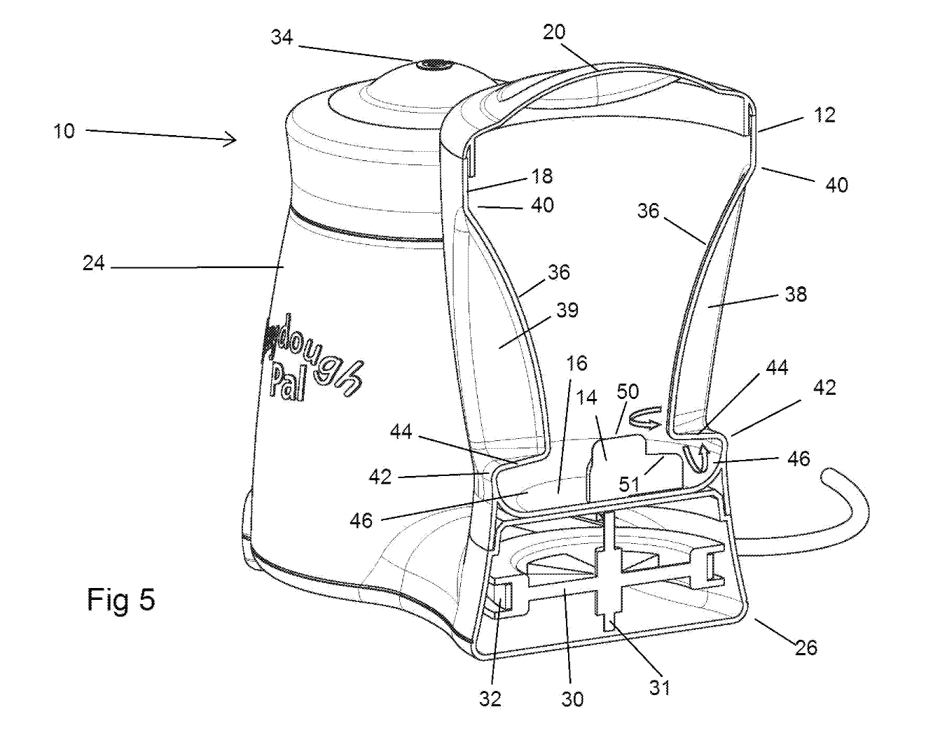

FIG. 6 is a perspective view of the play dough mixer of FIG. 1 with the mixing vessel detached and showing accompanying receptacles for storing play dough made with the play dough mixer.

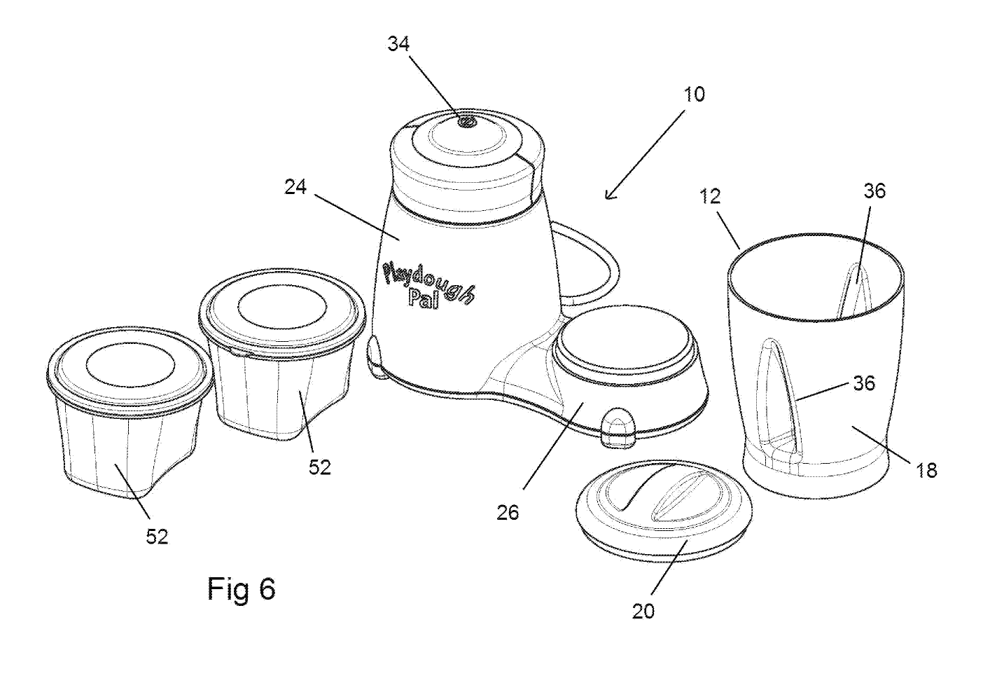

### DETAILED DESCRIPTION OF PREFERRED EMBODIMENTS

Referring to the Figures, there is shown a play dough mixer 10 comprising a mixing vessel 12 having a blade 14 therein for mixing a play dough mixture placed within the mixing vessel 12. The mixing vessel 12 comprises a circular lower wall 16 and a side wall 18 extending upwardly from the periphery of the lower wall 16. The blade 14 is located centrally on the lower wall 16. The side wall 18 defines a circular opening at the upper end thereof which is provided with a lid 20 to close off the mixing vessel 12 during use.

The play dough mixer 10 is provided with a drive motor 22 for rotating the blade 14 in the mixing vessel 12. The drive motor 22 is provided inside a motor housing 24 located alongside the mixing vessel 12. The motor housing 24 comprises a generally cylindrical housing having a longitudinal axis thereof oriented generally vertically.

The motor housing 24 includes a vessel base 26 extending horizontally outward from a lower end thereof. The vessel base 26 includes a circular upper surface onto which is received the mixing vessel 12. When the mixing vessel 12 is received on the vessel base 26, the mixing vessel 12 sits alongside the motor housing with the longitudinal axis thereof parallel to the longitudinal axis of the motor housing 24. The mixing vessel 12 is also detachable from the vessel base 26.

The motor housing 24 includes a first drive wheel 28 located below the drive motor 24 connected to a first shaft 29 extending from the drive motor 22. A second drive wheel 30 is provided in the vessel base 26 on a second shaft 31 mounted for rotation in the vessel base 26. A drive belt 32 is provided connecting the first drive wheel 28 to the second drive wheel 30. The second shaft 31 engages with the blade 14 through the lower wall 16 of the mixing vessel 12 when the mixing vessel 12 sits on the vessel base 26 such that rotation of the second shaft 31 causes rotation of the blade 14. The connection of the second shaft 31 through the vessel base 26 and the mixing vessel 12 to the blade 14 is of a known construction and therefore not represented in detail in the drawings.

Rotation of the first shaft 29 by the drive motor 22 thereby rotates the blade 14 via the first drive wheel 28, the drive belt 32, the second drive wheel 30 and the second shaft 31.

A power button 34 is provided on the motor housing 24 such that depressing the power button 34 activates the drive motor 22. The power button is provided on a circular upper surface of the motor housing 24. Internal circuitry (not shown) may provide a timer function such that the drive motor 22 operates for a predetermined time period once activated before switching off.

The side wall 18 of the mixing vessel 12 is generally cylindrical and is tapered such that the mixing vessel 12 has a larger cross sectional area adjacent the upper end thereof.

The side wall 18 includes one or more projections 36 extending inwardly from an inner surface thereof. The projections 36 are provided to aid mixing of the play dough mixture in the mixing vessel to obtain an even consistency. In the embodiment shown, there is provided a pair of projections located on the inner surface of the side wall 18 on opposite sides of the blade 14.

Each projection 36 comprises an elongate projection extending longitudinally along the inner surface of the side wall 18. The projections 36 have a generally triangular cross section wherein the inner surface of the side wall 18 comprises one side of the triangle. That is, the projections each include a first side face 38 and a second side face 39 extending inwardly into the mixing vessel 12. The first and second side faces 38 and 39 in the embodiment shown are orientated at an acute angle to each other.

The projections 36 each taper from an upper end 40 to a lower end 42 such that the lower end 42 is of a larger cross sectional area than the upper end 40.

In the embodiment shown, the upper end 40 tapers to have a zero cross sectional size.

The lower end 42 of each projection 36 is located above the lower wall 16 of the mixing vessel 12. The lower end 42 thereby includes a lower face 44 located above the lower wall 16 of the mixing vessel 12. The lower face 44 is generally planar and located above and parallel to the lower wall 16 such that a gap 46 is defined therebetween.

The blade 14 comprises a generally planar member secured at a first end thereof to a rotating hub 48. The blade 14 extends from the hub 48 such that the blade 14 lies in a radial plane with respect to the axis of rotation of the hub 48.

The blade 14 includes a stepped upper edge such that the upper edge includes a first portion 50 and a second portion 51 joined by a shoulder portion. The first portion 50 is generally parallel to the lower wall 16 of the mixing vessel 12 and adjacent the rotating hub 48. The first portion 50 is located above the lower face 44 of the projections 36. The second portion 51 is generally parallel to the lower wall 16 of the mixing vessel 12 and remote from the rotating hub 48. The second portion 51 is located below the lower face 44 of the projections 36 and extends into the gaps 46 defined under the projections 36.

The particular arrangement of the projections 36 and the blade 14 is provided to aid in creating a well mixed and consistent play dough.

In use, a play dough mixture comprising play dough ingredients is inserted into the mixing vessel 12 along with a pre-measured volume of liquid. The drive motor 22 is turned on with the power button 34 and the play dough mixture is mixed within the mixing vessel 12 until play dough of the required consistency is created. The physical arrangement of the motor housing 24, and the removable mixing vessel 12 mounted on the vessel base 26 provides an easy to use configuration that can be easily operated and allows the mixed dough to be removed by detaching and emptying the mixing vessel 12.

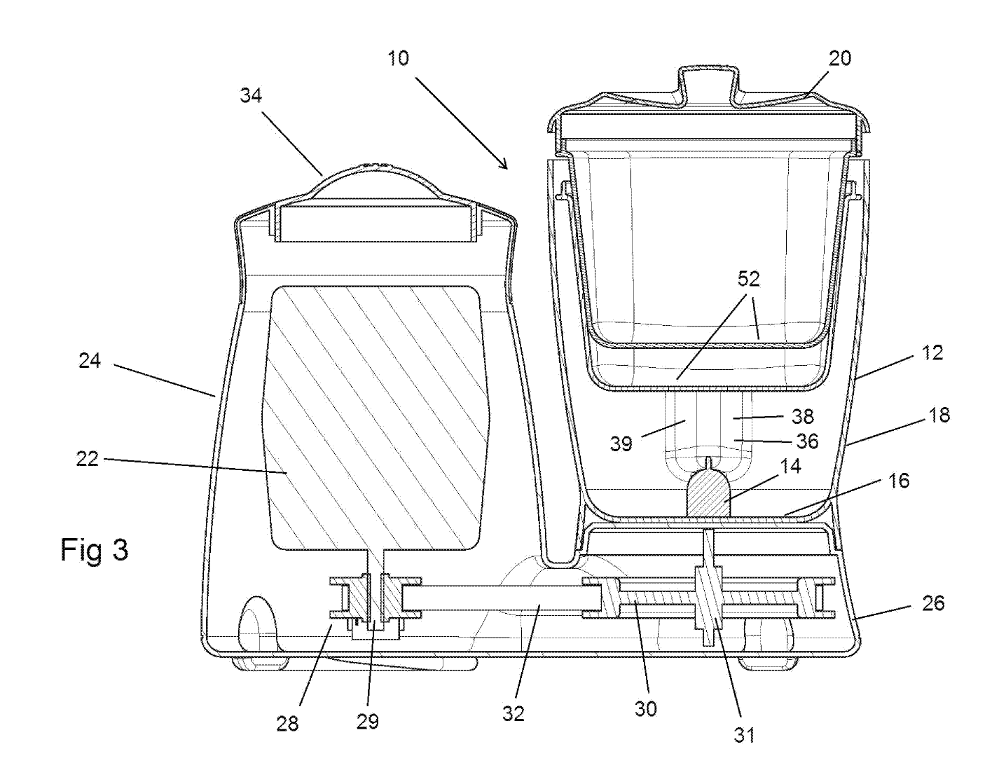

The play dough mixer 10 is also preferably provided with a plurality of receptacles 52. The receptacles 52 preferably stack inside each other and then inside the mixing vessel 12 (as can be seen in FIG. 3). The receptacles can be used for storing quantities of play dough created with the play dough mixer 10.

It will be readily apparent to persons skilled in the relevant arts that various modifications and improvements may be made to the foregoing embodiments, in addition to those already described, without departing from the basic inventive concepts of the present invention.

1. A play dough mixer comprising:
a mixing vessel having a lower wall and a side wall extending upwardly from the periphery of the circular lower wall;
a blade mounted adjacent the lower wall of the mixing vessel for rotation about a rotation axis, the blade comprising a planar member oriented radially with respect to the rotation axis;
a drive motor for rotating the blade; and
one or more longitudinal projections extending inwardly from an inner surface of the side wall;
wherein each projection includes a lower face located above and parallel to the lower wall of the mixing vessel such that a gap is defined therebetween and wherein the blade during rotation passes through said gaps.

2. A play dough mixer in accordance with claim 1, wherein each of the projections are tapered such that the projections increase in cross sectional size from an upper end to the lower end.

3. A play dough mixer in accordance with claim 2, wherein each projection has a generally triangular cross section such that first and second side faces of the projections are defined extending into the mixing vessel.

4. A play dough mixer in accordance with claim 3, wherein the first and second side faces are orientated at an acute angle to each other.

5. A play dough mixer in accordance with claim 2, wherein the upper ends of the projections taper to have a zero cross sectional size.

6. A play dough mixer in accordance with claim 1, wherein a pair of projections are provided located on the inner surface of the side wall on opposite sides of the blade.

7. A play dough mixer in accordance with claim 1 wherein the blade is secured at a first end thereof to a rotating hub.

8. A play dough mixer in accordance with claim 1, wherein the blade includes a stepped upper edge such that the upper edge includes a first portion and a second portion joined by a shoulder portion, the first portion being generally parallel to the lower wall of the mixing vessel and adjacent the rotating hub and second portion being generally parallel to the lower wall of the mixing vessel and remote from the rotating hub.

9. A play dough mixer in accordance with claim 8, wherein the first portion is located above the lower faces of the projections and the second portion is located below the lower faces of the projections such that the second portion extends into the gaps defined under the projections.

10. A play dough mixer in accordance with claim 1, wherein the drive motor is provided inside a motor housing located alongside the mixing vessel and the mixing vessel is locatable on a vessel base extending outwardly from a lower end of the motor housing.

11. A play dough mixer in accordance with claim 10, wherein the drive motor is provided with a first drive shaft that is coupled to a second drive shaft in the vessel base such that rotation of the drive motor rotates the second drive shaft and the second drive shaft engages with the mixing vessel on the vessel base to rotate the blade.

12. A play dough mixer comprising:
a motor housing having a drive motor mounted therein, the drive motor provided to rotate a first drive shaft;
a vessel base extending outwardly from a lower end of the motor housing;
a mixing vessel detachably mountable to an upper surface of the vessel base such that when mounted to the vessel base the mixing vessel is located alongside the motor housing;
a second drive shaft mounted within the vessel base;
wherein the first drive shaft is coupled to the second drive shaft such that rotation of the drive motor rotates the second drive shaft and the second drive shaft engages with the mixing vessel on the vessel base to rotate a blade provided within the mixing vessel.

13. A play dough mixer in accordance with claim 12, wherein the motor housing and the mixing vessel are both cylindrical in shape and the longitudinal axes of the motor housing and the mixing vessel are parallel and vertical when the mixing vessel is received on the vessel base.

14. A play dough mixer in accordance with claim 12, wherein a first drive wheel is connected to the first shaft below the drive motor, a second drive wheel is provided on the second shaft within the vessel base and a drive belt connects the first drive wheel to the second drive wheel such that rotation of the first shaft by the drive motor rotates the blade.

15. A play dough mixer in accordance with claim 10, wherein a power button is provided on an upper end of the motor housing such that depressing the power button activates the drive motor.

16. A play dough mixer in accordance with claim 15, wherein a timer is provided such that the drive motor operates for a predetermined time period once activated before switching off.

17. A play dough mixer in accordance with claim 12, wherein a power button is provided on an upper end of the motor housing such that depressing the power button activates the drive motor.

18. A play dough mixer in accordance with claim 17, wherein a timer is provided such that the drive motor operates for a predetermined time period once activated before switching off.
